(19) United States
(12) Patent Application Publication
(10) Pub. No.: US 2026/0200505 A1
(43) Pub. Date: Jul. 16, 2026

(54) A SERVICE VEHICLE WITH CENTER DRIVE, METHOD, AND SYSTEM THEREOF

(71) Applicant: AutoStore Technology AS, Nedre Vats (NO)

(72) Inventors: Trond Austrheim, Etne (NO); Martin Fitje, Etne (NO)

(21) Appl. No.: 19/131,858

(22) PCT Filed: Nov. 20, 2023
(86) PCT No.: PCT/EP2023/082437

§ 371 Date: May 21, 2025

(30) Foreign Application Priority Data
Nov. 29, 2022 (NO) 20221280

(51) Int. Cl. B61C 13/04; B61B 5/02; B61C 3/00; B61C 17/00; B61F 13/00; B65G 1/04

(52) U.S. Cl. CPC B61C 13/04; B61B 5/02; B61C 3/00; B61C 17/00; B61F 13/00; B65G 1/0464

(57) ABSTRACT

A service vehicle for operating on a grid of an automated storage and retrieval system, wherein the automated storage retrieval system comprises a rail system comprising a first set of parallel rails arranged to guide movement of a container handling vehicle in a first direction (X) across the top of a frame structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, wherein the service vehicle comprises a base with a set of wheels for traveling in first direction (X) and a set of wheels for traveling in the second (Y) direction, the base providing a platform for an operator, and a mechanism for changing the direction of travel, wherein the service vehicle comprises: a drive unit mounted to a rotatable platform part, the drive unit comprising a foot plate for the operator to stand on and an electric motor provided below the foot plate which drives a driven wheel that is arranged for engagement with a rail running under the service vehicle, the drive unit being arranged to require weight from the operator on the foot plate to allow the driven wheel to engage with the rail running under the service vehicle.

### FIELD OF THE INVENTION

The present invention relates to an automated storage and retrieval system for storage and retrieval of containers, in particular to a service vehicle operated by an operator on the storage and retrieval system for transporting a person out on the grid for service purposes.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301, 401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c, 401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO 2014/090684A1 or WO 2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO2020151866A1 describes a service vehicle for operation in an automated storage and retrieval system. The service vehicle is provided with a a displacement mechanism and a hoist arrangement which cooperate to move a container handling vehicle from the grid into a loaded position on the vehicle.

WO2021110616A1 describes a service vehicle for operation in an automated storage and retrieval system wherein the vehicle is provided with a platform mounted between the two-wheel modules. The platform also includes an enclosure with an opening that can be closed by a barrier.

WO2021078582A1 relates to a service vehicle operating in an automated storage and retrieval system. The system is provided with a main control system and a secondary control system to monitor and control the movements of the service vehicle.

WO2021249865A2 relates to a delivery vehicle provided with a rotational drive unit and a container carrier that rotates in relation to the base.

US2005047895A1 relates to autonomous vehicle provided with loading and unloading payload to transfer containers.

CN111268379A describes an omnidirectional logistics handling trolley provided with a lifting mechanism with telescopic plate that supports materials to be transferred in logistic environment.

There are several known solutions to service vehicles operating on the grid of a storage and retrieval system. These can be both manually operated by a person or they can be automatically operated by the central computer system. The manually operated service vehicle is e.g. in the form of a wheelchair solution where the operator is sitting in a seat and uses arm power to move the service vehicle around on the grid. There are further solutions where a person is situated inside a service vehicle where either the central computer system or the operator can control the movements of the service vehicle. The operator can use a set of controllers to manoeuvre the service vehicle or the route can be plotted into the central computer system. The problem with solutions like this is that a person manually moving and operating on the grid will cause a great delay due to the time it takes to manoeuvre on the grid. The whole grid or at least parts of the grid have to be shut down if a person is on the grid, hence there is a need for the shut-down of the grid to be as short a time as possible. With solutions where the service vehicle is operated by the central computer system the problem is that the operator is dependent on the central computer system. If the central computer system is down or the central computer system does not know where the container handling vehicle that needs service is on the grid the service vehicle cannot be used. If the service vehicle is controlled by the operator by plotting in a route the service vehicle takes on the grid, unnecessary time is spent operating the service vehicle.

### SUMMARY OF THE INVENTION

The present invention is set forth and characterized in the independent claims, while the dependent claims describe other characteristics of the invention.

The present invention relates to a. a service vehicle for operating on a grid of an automated storage and retrieval system, wherein the automated storage retrieval system comprises a rail system comprising a first set of parallel rails arranged to guide movement of a container handling vehicle in a first direction across the top of a frame structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, wherein the service vehicle comprises a base with a set of wheels for traveling in first direction and a set of wheels for traveling in the second direction, the base providing a platform for an operator, and a mechanism for changing the direction of travel, characterized in that the service vehicle comprises: a drive unit mounted to a rotatable platform part, the drive unit comprising a foot plate for the operator to stand on and an electric motor provided below the foot plate which drives a driven wheel that is arranged for engagement with a rail running under the service vehicle, the drive unit being arranged to require weight from the operator on the foot plate to allow the driven wheel to engage with the rail running under the service vehicle.

In one aspect, the rotatable platform part is situated between a plurality of brackets attached to an underside of the base and a set of brackets mounted to an upper-side of the base.

In one aspect, each of the brackets mounted on the underside of the base has a rolling device, optionally a wheel, that the rotatable platform part rests on.

In one aspect, each of the brackets mounted to the top of the base has a lip extending over the edge of the rotatable platform part.

In one aspect, the rotation of the rotatable platform part is controlled by a rotation locking pedal.

In one aspect, the rotation locking pedal has a locking clip corresponding to a notch in the brackets underneath the base for stopping the rotation of the platform.

In one aspect, the service vehicle is powered by the electric motor connected to an electric energy source.

In one aspect, the mechanism for changing direction of travel is controlled by a handle on a lever for lifting and lowering the wheels for travel in one direction.

In one aspect, the drive unit has a stand facing in the direction of travel.

In one aspect, the stand has a control panel with a control for starting the rotation of the driven wheel at a first speed.

In one aspect, the control for starting the rotation of the driven wheel at a first speed is at least one button.

In one aspect, a set of railings provided on the base have at least one closable barrier. In one aspect, the at least one closable barrier has to be securely closed and locked in order to operate the vehicle.

In one aspect, the railings have rubber blocks for engaging with other vehicles.

In one aspect, the foot plate has a track detector down pedal that can be pushed down by the operator for aiding the operator in locating the tracks underneath the service vehicle.

In one aspect, the service vehicle has guiding lines for showing a correct position of the vehicle for when changing the direction of travel.

In one aspect, the driven wheel engages with engages with both tracks of a rail running under the service vehicle.

In one aspect, the service vehicle is of the size of at least 2×2 grid cells which positions the rails the driven wheel engages with running under the centre of the vehicle

In one aspect, the foot plate can have a seat attached.

In one aspect, the service vehicle has two speed button and both speed buttons need to be pushed at the same time in order for the electric motor to start turning the driven wheel.

A system for operating a service vehicle for operating on the grid of an automated storage and retrieval system, the automated storage retrieval system comprises a framework structure comprising upright members and a storage volume comprising storage columns arranged in rows between the upright members, in these storage columns storage containers, are stacked one on top of one another to form stacks, a rail system comprising a first set of parallel rails arranged to guide movement of a vehicle in a first direction across the top of a frame structure, and a second set of parallel rails arranged perpendicular to the first set of rails to guide movement of the vehicle in a second direction which is perpendicular to the first direction, the first and second sets of parallel rails dividing the rail system into a plurality of grid cells wherein the service vehicle 501 is comprised of a base with a set of wheels for traveling in first direction and a set of wheels for traveling in the second direction, the base providing a platform for an operator, and a mechanism for changing the direction of travel, characterized in that the service vehicle is of the size of at least 2×2 grid cells which positions the rails the driven wheel engage with running under the centre of the vehicle.

The present invention also relates to a method for operating a service vehicle for operating on the grid of an automated storage and retrieval system, the automated storage retrieval system comprises a rail system comprising a first set of parallel rails arranged to guide movement of a vehicle in a first direction across the top of a frame structure, and a second set of parallel rails arranged perpendicular to the first set of rails to guide movement of the vehicle in a second direction which is perpendicular to the first direction, the first and second sets of parallel rails dividing the rail system into a plurality of grid cells, wherein the service vehicle comprises a base with a set of wheels for traveling in first direction and a set of wheels for traveling in the second direction, the base providing a platform for an operator, and a mechanism for changing the direction of travel, wherein the method is comprised of the following steps: apply weight to a foot plate to engage a driven wheel with a rail running under the service vehicle, using a controller on the control panel to start the rotation of the driven wheel remove weight from the foot plate to disengage the driven wheel from the rail running under the service vehicle.

In one aspect, close and lock a barrier of the service vehicle.

In one aspect, ensure the stand with control panel is facing in the desired direction of travel.

In one aspect, use a lever for lifting and lowering the wheels to switch to the needed wheel set.

In one aspect, using the controller on the control panel is pressing down one button on the control panel rotates the driven wheel at a first speed.

In one aspect, pressing down two buttons on the control panel rotates the driven wheel at a second speed.

In one aspect, changing direction of the service vehicle comprises the following steps: stopping in the correct position, moving track shift lever; release rotation stopper; and rotate drive unit in a new direction at 90 degrees to the previous direction.

This solution makes it easier to handle service problems on the grid since the operator can quickly and easily get onto the grid and handle the problem that needs to be solved. Further the operator can control the service vehicle when operating on the grid which makes it easier for the operator to manoeuvre on the grid since the operator might find the problem easier than the central computer system. This is particularly relevant if there is a container handling vehicle, the correct position of which on the grid is not known to the central computer system. The operator can see where the problem is and manoeuvre the service vehicle to the correct position and transport the broken down service vehicle back to the service area. This solution will in certain situations reduce the time needed to shut down the grid to perform a service or maintenance task. Also the fact that the service vehicle is operated by the operator both in terms of the direction of travel and the speed it is traveling, makes it possible to operate the service vehicle if the central computer system is down or the communication system is down.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of an embodiment of the present invention where the service vehicle is shown with an operator positioned at the foot plate.

FIG. 6 is a perspective partial cut through view of the lower part of an embodiment of the present invention where the operator is on board the service vehicle.

FIG. 7 is a side view of an embodiment of the present invention.

FIG. 8 is a perspective view, seen from below of the service vehicle of FIG. 5 showing the underside of the platform and the drive unit as well as the mechanical solution for changing the direction of travel.

FIG. 9 is a view of the service vehicle of FIG. 5 from directly above where a stand with a control panel of the service vehicle and the controls are displayed.

FIG. 10 is a perspective view of the drive unit with a stand and with a control panel of the service vehicle as seen in FIG. 5.

FIG. 11 is a perspective view of the stand with control panel of the service vehicle of FIG. 5 where an operator of the service vehicle is positioned on the foot plate of the drive unit.

FIGS. 12 and 13 is an alternative embodiment of the present invention where the foot plate 506 has a seat 1301 attached

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

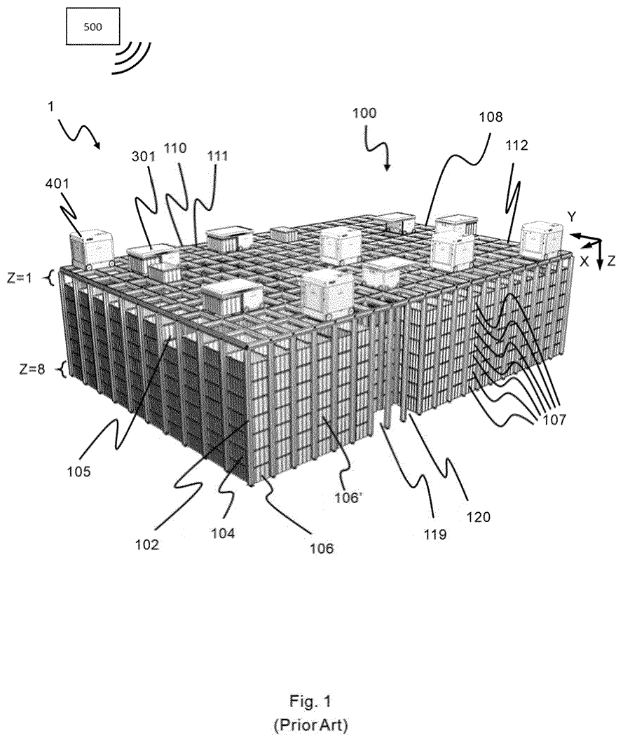

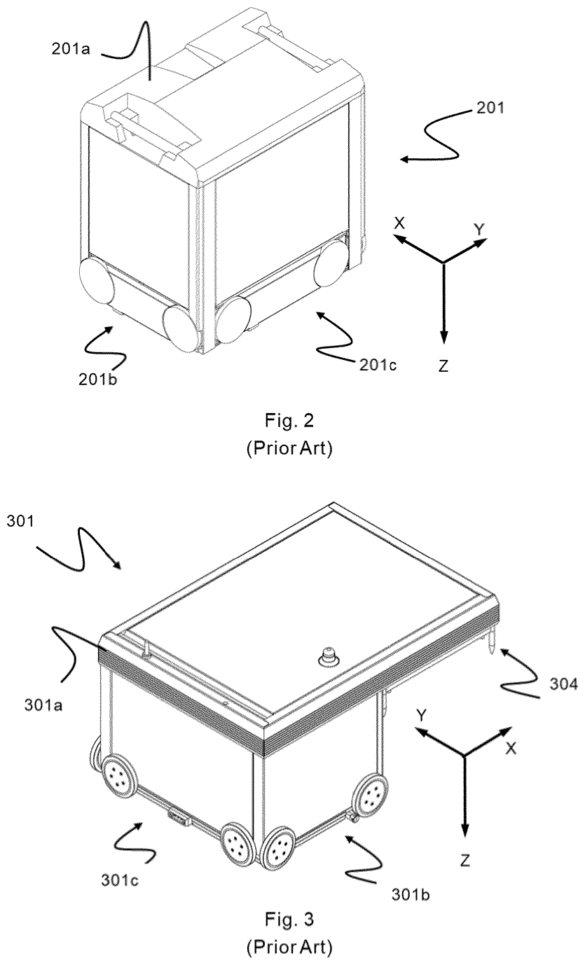

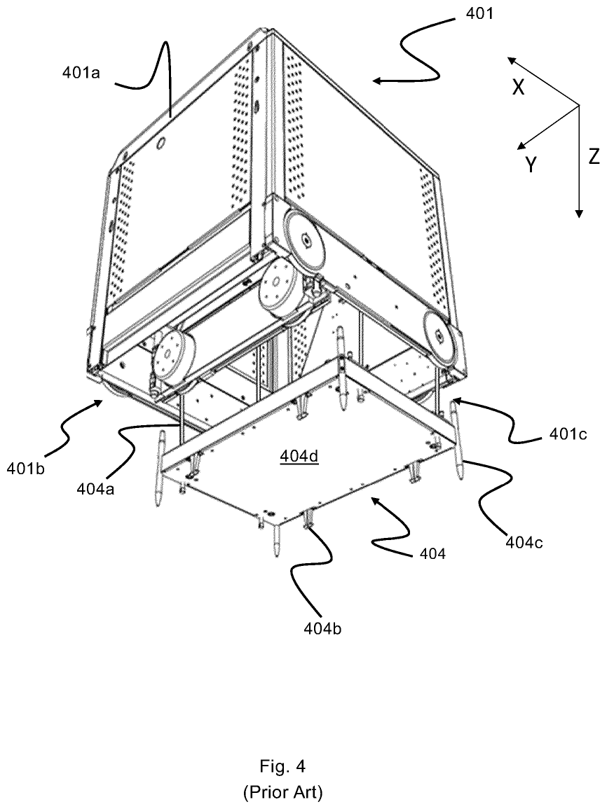

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

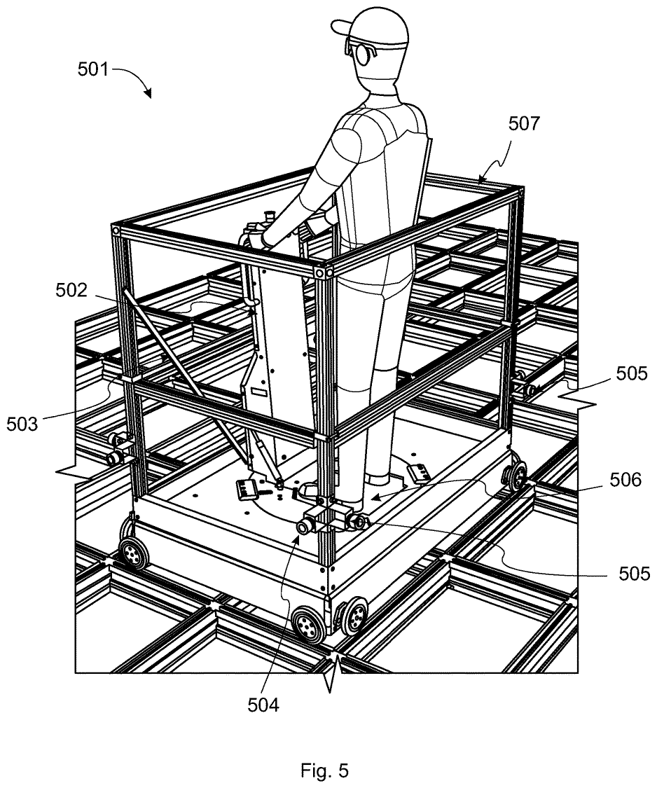

One embodiment of the automated storage and retrieval system according to the invention will now be discussed in more detail with reference to FIGS. 5-11.

FIG. 5 is a perspective view of an embodiment of the present invention where the service vehicle 501 is displayed with an operator positioned on the foot plate 506.

The service vehicle 501 comprises a base 504 with a set of protective railings 507 surrounding the area where the operator is positioned.

The base 504 covers an area of at least 2×2 grid cells. The area the service vehicle 501 covers can be greater than this. The at least 2×2 cell coverage area is beneficial for the drive unit to function and engage with the tracks on the rails of the grid.

The service vehicle 501 has at least 8 wheels that determine the way the service vehicle 501 is traveling. There are at least a set of 4 wheels for traveling in a first X-direction. Further the service vehicle 501 has at least a set of 4 wheels for traveling in a second Y-direction. The direction of travel is dependent on which set of wheels is in contact with the tracks of the rails forming the grid of the storage and retrieval system.

Which set of wheels is in contact with the tracks of the grid is decided with lever 503. The lever 503 can have a handle and be manually switched between at least 2 positions. One position is for engaging the set of wheels with the tracks of the grid for traveling in the first X-direction and the other position is for engaging the set of wheels with the tracks of the grid for traveling in the second Y-direction.

In addition to these two positions there can be a third position where both the set of wheels for traveling in the first X-direction and the set of wheels for traveling in the Y-direction engage with the tracks on the grid. This position is for securing the service vehicle 501 from moving. This might be desirable when the operator is entering the vehicle, or when the operator is starting the procedure for operating the service vehicle 501 or to make the service vehicle 501 steady when the service vehicle 501 is changing the direction of travel.

In an alternative solution, which set of wheels engages with the tracks can be controlled by an automatic solution. This solution might be operated by buttons or similar that controls a motor that changes the set of wheels engaging with the tracks of the grid.

Manually changing the direction of travel might be preferable since it might be steadier and safer for the operator on board the service vehicle 501.

Further the railings 507 that surround the base where the operator is situated can have a barrier 601 that can be opened and closed. This barrier 601 makes it easier for the operator to enter the service vehicle 501. However, the barrier 601 needs to be closed securely before the service vehicle 501 can move with the operator on board. The barrier 601 can therefore have a sensor that disables the operation of the service vehicle 501 until the sensor registers that the barrier 601 is properly locked. This barrier 601 might be in the form of a hinged door or it might be in the form of a bar of the railings 507 that can be lifted in order to make access to the base 504 of the service vehicle 501 easier.

Further the railings 507 can have a set of rubber blocks 505. These rubber blocks 505 are placed in positions that ensure that they will be the only part of the service vehicle 501 that is in contact with a container handling vehicle that the service vehicle 501 is trying to service.

In FIG. 5 it can be seen that the operator is standing on a foot plate 506 of the drive unit of the service vehicle 501. The foot plate 506 may be part of a stand with a control panel 502. On the stand with the control panel 502, the controls for operating the service vehicle 501 may be situated. Further the stand with control panel 502 can have handles for the operator to hold on to in order to steady the operator as the service vehicle 501 travels over the grid of the storage and retrieval system.

The stand can also rotate so that the operator of the service vehicle 501 always faces in the direction of travel. The foot plate 506 is provided as part of a drive unit. The drive unit comprises an electric motor 805 that can turn a driven wheel 806 around. The driven wheel 806 is attached to the foot plate 506 and can be pushed down on the tracks of the underlying rail by the weight of the operator standing on the foot plate 506. When the foot plate 506 is pushed down by the weight of the operator, the driven wheel 806 engages with the tracks of the rails of the grid of the storage and retrieval system and the operator can start the electric motor 805 and the driven wheel 806 will start to rotate and propel the service vehicle 501 forward.

The sides of the service vehicle 501 are stepped in from the position of the rails. This allows the service vehicle 501 to get close to e.g. derailed container handling vehicles.

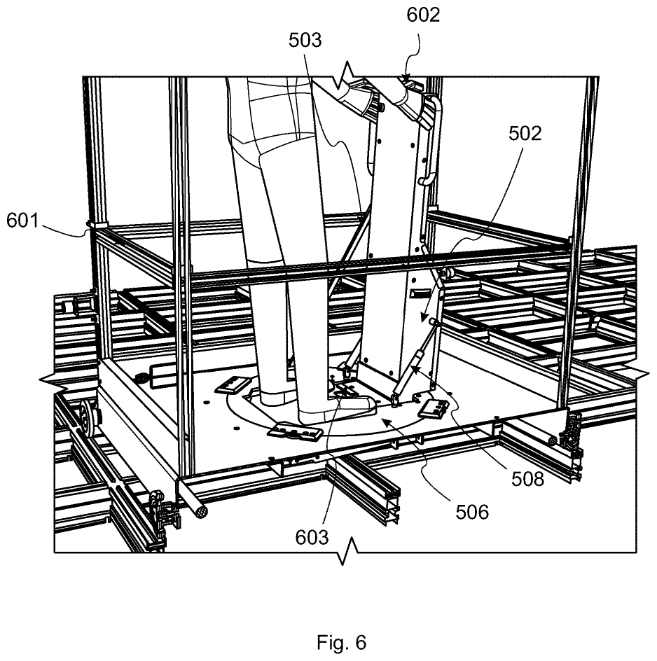

FIG. 6 is a perspective partial cut through of the lower part of the present invention where the operator is on board the service vehicle 501.

The set of wheels is in contact with the tracks on the grid is controlled with a lever 503. The lever 503 can be in the form of a handle that can be manually switched between at least 2 positions. One position is for engaging the set of wheels with the tracks of the grid for traveling in the first X-direction and the other position is for engaging the set of wheels with the tracks of the grid for traveling in the second Y-direction.

In addition to these two positions there can be a third position where both the set of wheels for traveling in the first X-direction and the set of wheels for traveling in the Y-direction is engaging with the tracks on the grid. This position is for securing the service vehicle 501 from moving. This might be necessary when the operator is entering the vehicle, or when the operator is starting the procedure for operating the service vehicle 501 or as a middle position for steadying the service vehicle 501 when the service vehicle 501 is changing the direction of travel.

The foot plate 506 has a pedal that allow the operator to push down a track detector 810 in order to help the operator to find the correct position.

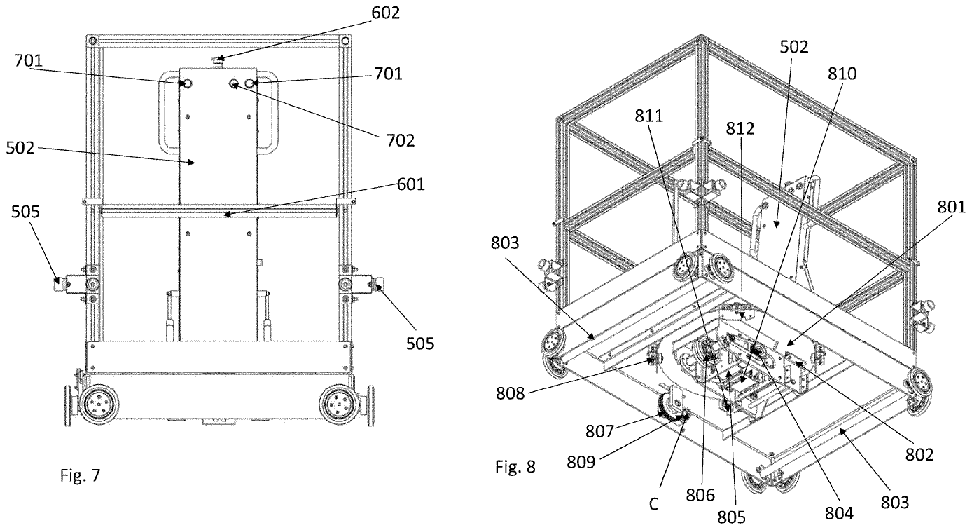

FIG. 7 is a side view of an embodiment of the present invention. Here the controllers of the stand with control panel 502 are seen. On top of the stand with control panel 502 there is an emergency stop button 602. This emergency stop button 602 is in order to stop the service vehicle 501 in an emergency situation, for example if the service vehicle 501 is unstable or if something is wrong with the service vehicle 501. Further it is shown that the stand with control panel 502 has two speed buttons 701. The two speed buttons 701 allow the operator to control the speed the service vehicle 501 is traveling in. When the weight of the operator pushes down the foot plate 506 and the operator push one button, the service vehicle 501 will travel at a first speed. If the operator pushes both buttons the service vehicle 501 will travel at a second speed. In an embodiment of the present invention pushing one button, the service vehicle 501 will travel in a first slow speed, e.g. 0,05 m/s. By pushing in both buttons, the service vehicle 501 will travel in a second speed, e.g. 0,5 m/s.

In an alternative solution, the two speed buttons 701 may have different speed indications. The service vehicle 501 may have 3 different traveling speeds. A first button will propel the service vehicle 501 in one speed and the second button will propel the service vehicle 501 at a second speed and pushing both buttons will propel the service vehicle 501 at a third speed. The speed might be arranged to change in accordance with the number of times the buttons are pushed.

Further the control stand has an on/off-button 702. This button turns the service vehicle 501 on and off.

FIG. 8 is a perspective view of underside of the service vehicle 501 displaying the drive unit and the mechanical solution for changing the direction of travel.

In an embodiment of the present invention, the wheels for traveling in an X-direction are connected in pairs by an axle 803 spanning the width of the service vehicle 501. The axles 803 are connected at one end to the mechanism for changing direction of travel. The mechanism changing direction of travel allows the wheels for traveling in the X-direction to be raised and lowered. When the wheels are raised the service vehicle 501 can travel in the Y-direction and when the wheels are lowered the service vehicle 501 can travel in the X-direction. When the wheels for traveling in the X-direction are raised, the wheels for traveling in the Y-direction are in contact with the tracks, and when the wheels for traveling in the X-direction are lowered, the X-direction wheels are in contact with the tracks of the X direction rails and the Y direction wheels are lifted free. There is a further possibility that both the wheels for traveling in the X-direction and the wheels for traveling in the Y-direction are in contact with the tracks of the X and Y direction rails at the same time. This is in order to ensure that the service vehicle 501 does not move, and stays locked in one position. This could be necessary during the time the service vehicle 501 is either performing service on the grid or other vehicles, or it could be necessary when the operator is entering or exiting the service vehicle 501 or if the service vehicle 501 is parked when not in use.

The wheels for traveling in the Y-direction are not connected by axles. These wheels are attached to the body of the service vehicle 501 and cannot be lifted or lowered other than through the lifting and lowering movements of the X-direction wheels and movement of the base of the service vehicle as a whole.

In the embodiment of the invention, the mechanism for changing direction of travel comprises a wheel lift mechanism. The wheel lift mechanism comprises a coupling link, a first rocker link, a second rocker link, a pivot link, and a wheel lift gear 809. The first rocker link connects the coupling link and the service vehicle 501 body, and the second rocker link connects the coupling link and the service vehicle 501 body. The pivot link connects the coupling link and the center axis C of the wheel lift gear 809.

The pivot link comprises a first link and a second link. The first link is pivotally connected to the wheel lift gear 809 (via the center axis C of the wheel lift gear 809) in a first end and pivotally connected to a first end of the second link in a second end. A second end of the second link is pivotally connected to the coupling link. The first link and the second link rotate together.

The lever 503 of the wheel lift mechanism assembly is manually operable by the operator for actuating the wheel lift mechanism between the first position and the second position. The actuator assembly comprises an actuator gear 807 and the lever 503 are connected to the actuator gear 807.

The wheel lift mechanism is disclosed with a wheel lift gear 809 engaged with the actuator gear 807. As shown, the actuator gear 807 has a larger gear circumference than the wheel lift gear 809.

In an alternative solution the mechanism for changing the direction of travel is controlled in the same manner as for container handling vehicles. In this solution the wheels for traveling in the X-direction can be raised and lowered by electric motors. The driving mechanism comprises a driven wheel 806 for engaging with the tracks of the rails. The driven wheel 806 can be of one track width. A driven wheel 806 with one track width only engages with one track on the rails. Alternatively, the driven wheel 806 can be of the width of two tracks. A driven wheel 806 of the width of two tracks engages with both tracks of a rail. This solution gives a better frictional grip between the driven wheel 806 and the tracks of the rails ensuring that there is lower risk of the driven wheel 806 slipping while it is in operation.

The driven wheel 806 is connected to an electric motor 805 via a driving belt 804. The driving belt 804 is connected to the rotor of the electric motor 805. Further the belt 804 is connected to the axle of the driven wheel 806. The electric motor 805 is powered by an electric power source like a battery or a capacitor or both. Both the electric motor 805 and the driven wheel 806 is attached to a frame structure. The frame structure is attached to a foot plate 506 with mountings 802. The foot plate 506 is positioned in a rotatable platform part 801 that can be rotated 360° in either direction. The rotatable platform part 801 is secured to the base 504 by a number of brackets 808. In a preferred embodiment there are 4 brackets 808. The brackets 808 are attached to the base 504 of the service vehicle 501. The brackets 808 are bolted to the bottom of the base 504 of the service vehicle 501. A wheel is provided on each of the brackets 808. The rotatable platform part 801 rests on the wheels. The wheels allow the rotatable platform part 801 to rotate. On the top side of the base 504 the rotatable platform part 801 is held in place by a set of plates that are mounted to the upper-side of the base 504 and that has a lip that extends over the edge of the rotatable platform part 801. The wheels on the underside and the lip extending over the edge of the rotatable platform part 801 holds the rotatable platform part 801 in place in the base 504 and allows it to rotate.

The rotation of the rotatable platform part 801 is locked in place by a locking clip 811 that is attached to the rotatable platform part 801. The locking clip 811 is positioned such that it interacts with the brackets 808 holding the wheels on which the rotatable platform part 801 rests. The brackets 808 have notches 812 into which the locking clip 811 fits. The brackets 808 are spaced 90° from each other allowing the rotatable platform part 801 with the foot plate 506 and the stand with a control panel 502 to lock in position so that it faces in the traveling direction of the service vehicle 501. The locking clip 811 is controlled by a pedal on the top side of the rotatable platform part 801. The pedal controlling the locking clip 811 is used to release the rotatable platform part 801 from a locked state and allowing the rotatable platform part 801 to turn.

The driven wheel 806, when changing direction of travel, is rotated about a vertical axis that aligns with the cross-over of the rails when it is turned as a result of the driven wheel's 806 center drive location in the middle of the vehicle. The horizontal rotational axis of the driven wheel 806 is off-set with respect to the driven wheel 806 and rotatable platform part's vertical axis of rotation so that the driven wheel 806 ends up directly under the operator's weight. This aids the frictional grip of the driven wheel on the underlying rail. This also allow for the positioning of a sensor on that vertical axis aligned with the cross-over of the rails.

Under the electrical motor 805 there is positioned a track detector 810. The track detector 810 allows the operator to detect the position of the track underneath the service vehicle 501. The track detector 810 helps the operator to position the service vehicle 501 correctly for changing the direction of travel.

The track detector 810 is connected to the track detector down pedal 603. When the operator pushes on the track detector down pedal 603 the track detector 810 is pushed down and interacts with the tracks running perpendicular to the tracks the driven wheel engages with underneath the service vehicle 501. The track detector 810 is a plate that allows the operator to detect the track underneath the service vehicle 501 when the track detector down pedal 603 is pushed down. When the operator feels the track detector 810 interacting with the tracks, the operator can change the direction of travel. The track detector can be engaging with one track or with both tracks. The operator will know if the track detector is engaging with the tracks if the pedal is down and the service vehicle will not move.

The operator could be aided by lines marked on the top of the base of the service vehicle that line up with the tracks running under the service vehicle when the service vehicle is positioned properly.

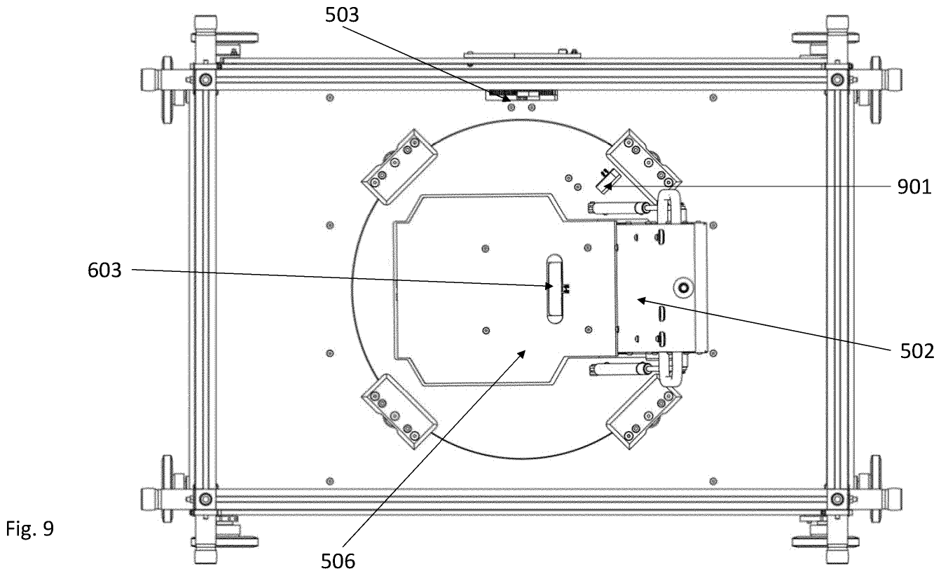

FIG. 9 is a view of the service vehicle 501 from directly above where the stand with a control panel 502 and the controls are displayed. The handle of the lever 503 for changing direction of travel is displayed along the side of the service vehicle 501. Further the circular, rotatable platform part 801 is placed at the center of the base 504 of the service vehicle 501. The circular, rotatable platform part 801 can turn around 360° in both directions. The turning of the rotatable platform part 801 is controlled by a pedal of a rotation stopper 901. The rotation stopper 901 is a locking clip 811 that engages with a notch 812 on the brackets underneath the base 504 of the service vehicle 501. By pushing on the rotation stopper pedal 901 the locking clip 811 is released which allow the rotatable platform part 801 to rotate. When the rotatable platform part 801 rotates the locking clip 811 will engage with the next notch 812 in a bracket as long as the rotation stopper pedal 901 is not pushed down.

In addition to this the track detector 810 down pedal 603 is positioned towards the front of the foot plate 506.

In order to drive the service vehicle 501, the following steps needs to be taken. The barrier or barriers 601 need to be closed properly. The driving unit needs to be in the correct direction. The handle for shifting the direction of travel needs to be pushed in the direction allowing for the correct set of wheels to engage with the tracks of the rails. The operator stands on the foot plate 506 which pushes the driven wheel 806 down, so it engages with the tracks of the rails. The operator's weight on the foot plate 506 causes it to pivot with respect to the base of the service vehicle and trigger a sensor confirming for the service vehicle that the operator is present. Then the operator needs to push at least one of the speed buttons 701 (e.g.: for fast drive (0,5 m/s) press and hold both buttons down; and for slow drive press either button one button (0,05 m/s)).

In an embodiment of the present invention both speed buttons need to be pushed in at the same time in order for the electric motor to start turning and the driven wheel to start spinning. In this embodiment the buttons are located close to the handlebars in on either side of the control panel. This ensures that the operator has both hands inside the service vehicle when it is moving.

In order to change the direction of travel the following steps needs to be taken: Stop over four cells and over a junction in the underlying rails running under the service vehicle and perform a track-shift using the lever. Release a rotation stopper pedal. Rotate the drive unit into a new direction with hand force. Use the weight of the operator to press down driven wheel 806 by the operator stepping onto the foot plate of the drive unit. Press one or both of the drive buttons (or actuate another drive control provided in place of the buttons).

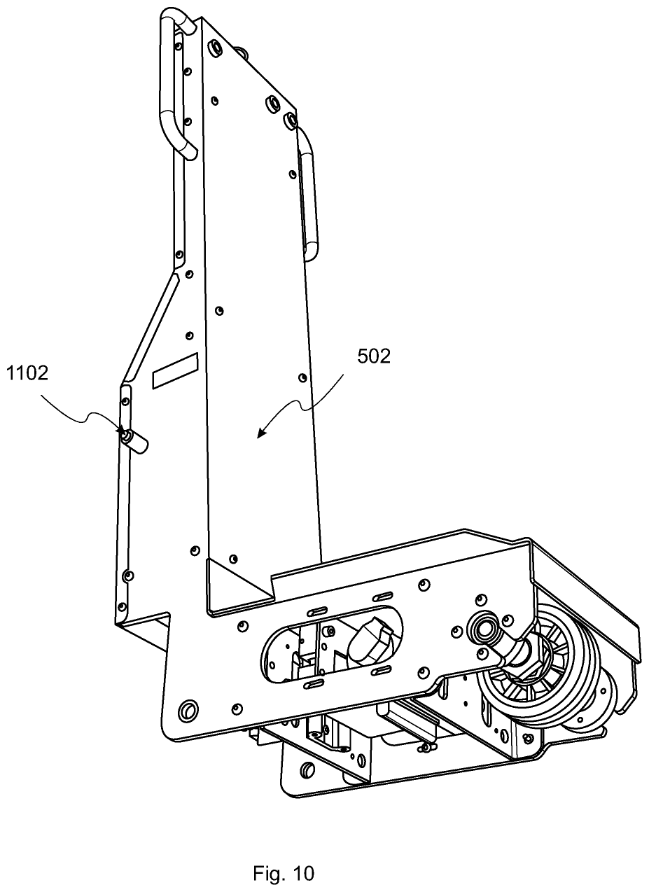

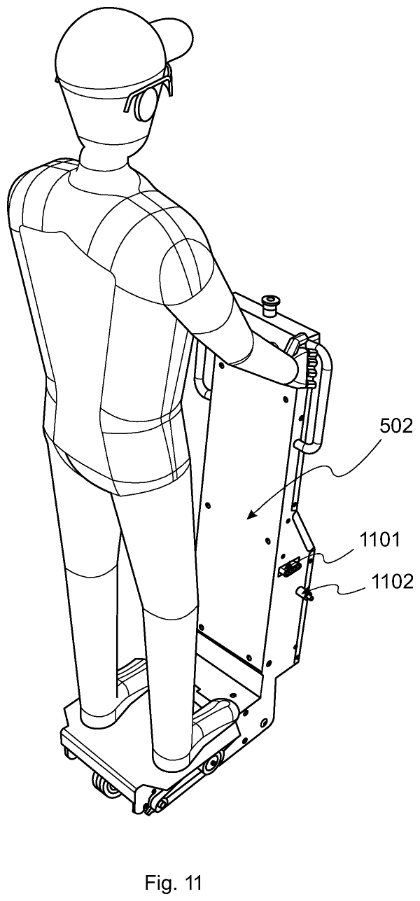

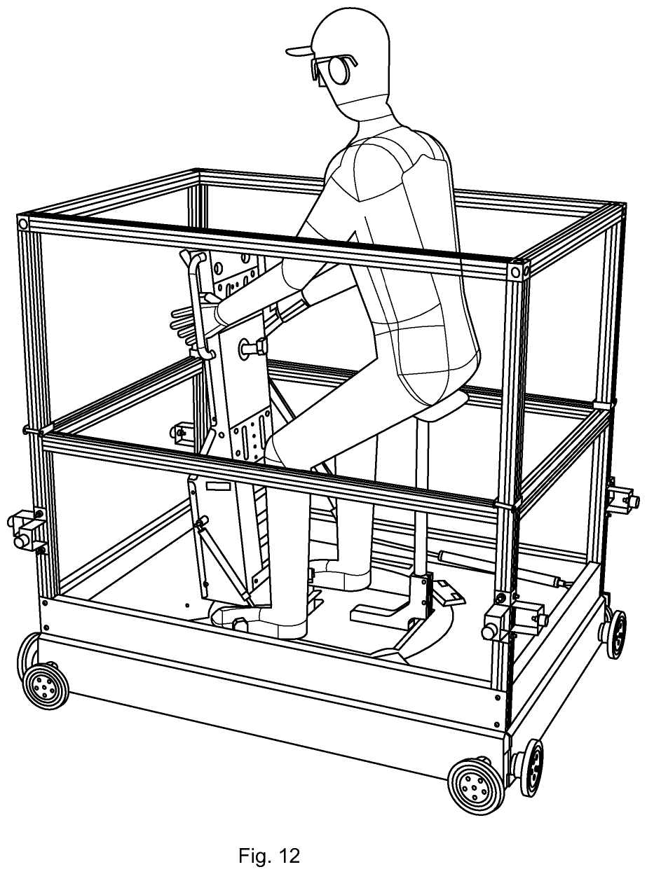

FIGS. 10 and 11 is a perspective view of the stand with control panel 502 of the service vehicle 501 and the driving mechanism. The stand with control panel 502 (L-shaped body) comprises a foot plate 506 that is mounted on top of the framework holding the driving mechanism. Further the footplate and the frame holding the driving unit is connected to an upright portion. The upright portion comprises the control panel. The control panel holds the buttons for operating the service vehicle 501. The upright portion also comprises handles that is used by the operator to hold on to during the travel of the service vehicle 501.

The stand is pivotally mounted to the rotatable platform part 801. When the operator is positioned on the foot plate 506 this changes the angle of the stand through pivoting of the L-shaped body with respect to the rest of the service vehicle 501. This in turn tries to compress struts 508 mounted between the upright portion of the stand and the rotatable platform part 801. The compression of the struts 508 is against a bias provided by springs or compressed fluid, or both. When the operator is no longer positioned on the foot plate 506 the struts 508 ensure that the driven wheel 806 is lifted up from the tracks of the rails. There is a strut 508 attached to each side of the upright portion. The mounting points 1102 for struts 508 are positioned on the sides of the upright portion. Further the upright portion can hold the power storage unit of the service vehicle 501 and a connector 1101 for charging the power storage.

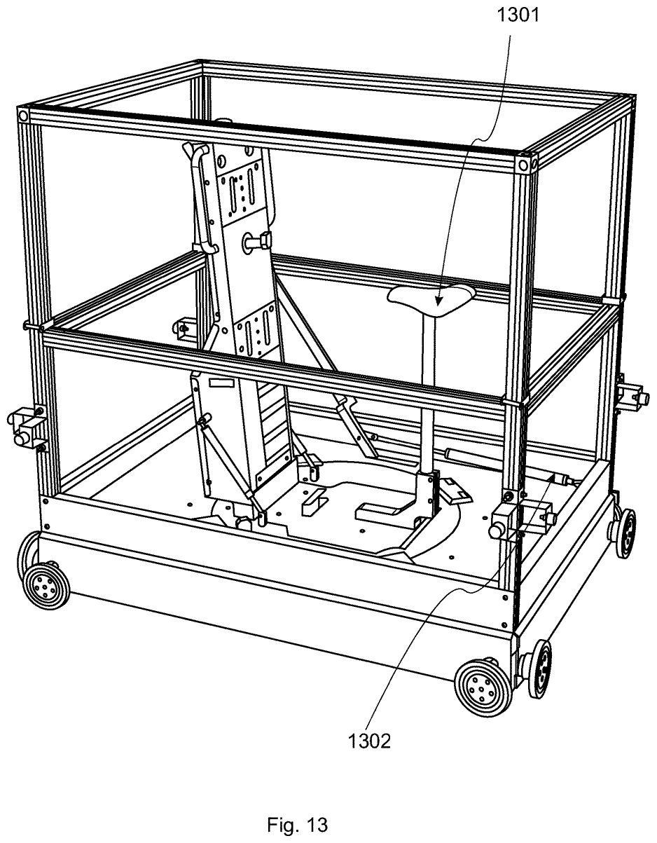

FIGS. 12 and 13 is an alternative embodiment of the present invention where the foot plate 506 has a seat 1301 attached. The seat 1301 is attached to the foot plate 506 in order for the weight of the operator to be on the foot plate 506 and push the driven wheel 806 down. Further the lever 503 for manual track shift has a locking device 1302 that ensures that the lever stays in position during travel.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

### Prior Art (FIGS. 1-4):

1 Prior art automated storage and retrieval system
100 Framework structure
102 Upright members of framework structure
104 Storage grid
105 Storage column
106 Storage container
106′Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
50 Service vehicle
502 Stand with control panel
503 Lever (for manual track shift)
504 Base
505 Rubber blocks
506 Foot plate
507 Protective railings
508 Struts
601 barrier
602 Emergency stop button
603 Track detector down pedal
701 Speed buttons
702 ON/OFF-button
801 Rotatable platform part/platform
802 Mountings (for frame of driven wheel mechanism)
803 Axle (for wheels traveling in X-direction).
804 Driving belt (for transferring energy from motor to driven wheel)
805 Electric motor
806 Driven wheel
807 Actuator gear
808 Brackets (mounting brackets for base)
809 Wheel lift gear
810 Track detector
811 Locking clip
812 Notch (for receiving locking clip)
C Centre axis of the wheel lift gear
901 Pedal of rotation stopper
1101 Connector (for charger)
1102 Mounting points (for telescopic struts)
1301 Seat
1302 Locking device
X First direction
Y Second direction
Z Third direction

1-28. (canceled)

29. A service vehicle for operating on a grid of an automated storage and retrieval system, wherein the automated storage retrieval system comprises a rail system comprising a first set of parallel rails arranged to guide movement of a container handling vehicle in a first direction across the top of a frame structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, wherein the service vehicle comprises a base with a set of wheels for traveling in the first direction and a set of wheels for traveling in the second direction, the base providing a platform for an operator, and a mechanism for changing the direction of travel, characterized in that the service vehicle comprises:
a drive unit mounted to a rotatable platform part, the drive unit comprising a foot plate for the operator to stand on and an electric motor provided below the foot plate which drives a driven wheel that is arranged for engagement with a rail running under the service vehicle, the drive unit being arranged to require weight from the operator on the foot plate to allow the driven wheel to engage with the rail running under the service vehicle.

30. The service vehicle according to claim 29, wherein the rotatable platform part is situated between a plurality of brackets attached to an underside of the base and a set of brackets mounted to an upper-side of the base, and
optionally wherein each of the brackets mounted on the underside of the base has a rolling device, optionally a wheel, that the rotatable platform part rests on.

31. The service vehicle according to claim 30, wherein each of the brackets mounted to the upper-side of the base has a lip extending over the edge of the rotatable platform part.

32. The service vehicle according to claim 31, wherein the rotation of the rotatable platform part is controlled by a rotation locking pedal.

33. The service vehicle according to claim 32, wherein the rotation locking pedal has a locking clip corresponding to a notch in the brackets underneath the base for stopping the rotation of the platform.

34. The service vehicle according to claim 29, wherein the service vehicle is:
powered by the electric motor connected to an electric energy source; and/or of the size of at least 2×2 grid cells which positions the rails the driven wheel engage with running under the centre of the vehicle.

35. The service vehicle according to claim 29, wherein the mechanism for changing direction of travel is controlled by a handle on a lever for lifting and lowering the wheels for travel in one direction.

36. The service vehicle according to claim 29, wherein the drive unit has a stand facing in the direction of travel, and optionally wherein the stand has a control panel with a control for starting the rotation of the driven wheel at a first speed, and optionally wherein the control for starting the rotation of the driven wheel at a first speed is at least one button.

37. The service vehicle according to claim 29, wherein a set of railings provided on the base have at least one closable barrier, and optionally wherein the at least one closable barrier has to be securely closed and locked in order to operate the vehicle.

38. The service vehicle according to claim 37, wherein the railings have rubber blocks for engaging with other vehicles.

39. The service vehicle according to claim 29, wherein the foot plate has one or more of:
a track detector down pedal that can be pushed down by the operator for aiding the operator in locating the tracks underneath the service vehicle; and
a seat attached.

40. The service vehicle according to claim 29, wherein the service vehicle has one or more of:
guiding lines for showing a correct position of the vehicle for when changing the direction of travel; and
two speed buttons, wherein both the speed buttons need to be pushed at the same time in order for the electric motor to start turning the driven wheel.

41. The service vehicle according to claim 29, wherein the driven wheel engages with engages with both tracks of a rail running under the service vehicle.

42. A system for operating a service vehicle according to claim 29, for operating on the grid of an automated storage and retrieval system, the automated storage retrieval system comprises a framework structure comprising upright members and a storage volume comprising storage columns arranged in rows between the upright members, in these storage columns storage containers, are stacked one on top of one another to form stacks, a rail system comprising a first set of parallel rails arranged to guide movement of a vehicle in a first direction across the top of a frame structure, and a second set of parallel rails arranged perpendicular to the first set of rails to guide movement of the vehicle in a second direction which is perpendicular to the first direction, the first and second sets of parallel rails dividing the rail system into a plurality of grid cells wherein the service vehicle is comprised of a base with a set of wheels for traveling in the first direction and a set of wheels for traveling in the second direction, the base providing a platform for an operator, and a mechanism for changing the direction of travel, characterized in that the service vehicle is of the size of at least 2×2 grid cells which positions the rails the driven wheel engage with running under the centre of the vehicle.

43. A method for operating a service vehicle for operating on a grid of an automated storage and retrieval system, the automated storage retrieval system comprises a rail system comprising a first set of parallel rails arranged to guide movement of a vehicle in a first direction across the top of a frame structure, and a second set of parallel rails arranged perpendicular to the first set of rails to guide movement of the vehicle in a second direction which is perpendicular to the first direction, the first and second sets of parallel rails dividing the rail system into a plurality of grid cells, wherein the service vehicle comprises a base with a set of wheels for traveling in the first direction and a set of wheels for traveling in the second direction, the base providing a platform for an operator, and a mechanism for changing the direction of travel, wherein the method comprises:
applying weight to a foot plate to engage a driven wheel with a rail running under the service vehicle;
using a controller on a control panel to start the rotation of the driven wheel; and
removing weight from the foot plate to disengage the driven wheel from the rail running under the service vehicle.

44. A method for operating a service vehicle according to claim 43, further comprising closing and locking a barrier of the service vehicle.

45. A method for operating a service vehicle according to claim 43, further comprising ensuring a stand with the control panel is facing in the desired direction of travel.

46. A method for operating a service vehicle according to claim 43, further comprising using a lever for lifting and lowering the wheels to switch to the needed wheel set, and/or using the controller on the control panel to press down one button on the control panel to rotate the driven wheel at a first speed.

47. A method for operating a service vehicle according to claim 46, wherein pressing down two buttons on the control panel rotates the driven wheel at a second speed.

48. A method for operating a service vehicle according to claim 47, wherein changing direction of the service vehicle comprises:
stopping in a correct position;
moving a track shift lever;
releasing a rotation stopper; and
rotating drive unit in a new direction at 90 degrees to the previous direction.
